(19) United States
(12) Patent Application Publication
(10) Pub. No.: US 2013/0212353 A1
(43) Pub. Date: Aug. 15, 2013

(54) System for implementing vector look-up table operations in a SIMD processor

(71) Applicant: Tibet Mimar, Sunnyvale, CA (US)

(72) Inventor: Tibet Mimar, Sunnyvale, CA (US)

(21) Appl. No.: 10/357,900

(22) Filed: Feb. 3, 2003

Related U.S. Application Data
(60) Provisional application No. 60/354,352, filed on Feb. 4, 2002.

(51) Int. Cl. G06F 9/30

(52) U.S. Cl. CPC G06F 9/30036
USPC 712/4

(57) ABSTRACT

The present invention incorporates a system for vector Look-Up Table (LUT) operations into a single-instruction multiple-data (SIMD) processor in order to implement plurality of LUT operations simultaneously, where each of the LUT contents could be the same or different. Elements of one or two vector registers are used to form LUT indexes, and the output of vector LUT operation is written into a vector register. No dedicated LUT memory is required; rather, data memory is organized as multiple separate data memory banks, where a portion of each data memory bank is used for LUT operations. For a single-input vector LUT operation, the address input of each LUT is operably coupled to any of the input vector register's elements using input vector element mapping logic in one embodiment. Thus, one input vector element can produce (a positive integer) N output elements using N different LUTs, or (another positive integer) K input vector elements can produce N output elements, where K is an integer from one to N.

### CROSS-REFERENCE TO RELATED APPLICATIONS

This patent claims the benefit of priority of U.S. Patent Application No. 60/354,352, entitled “METHOD FOR IMPLEMENTING VECTOR LOOK-UP TABLE OPERATIONS IN A SIMD PROCESSOR,” filed on Feb. 4, 2002, which is incorporated herein by reference.

### BACKGROUND OF THE INVENTION

1. Field of the Invention

The invention relates generally to the field of processor chips and specifically to the field of single-instruction multiple-data (SIMD) processors. This invention has utility in a VLIW processor where one of the instructions is of SIMD type. More particularly, the present invention relates to Look-Up Table Operations in a SIMD processing system.

2. Description of the Background Art

Vector Look-Up Table (LUT) operation is frequently used in image and video processing. Typical applications include gamma correction, scaling, and morphological operators. For example, real-time gamma correction or scaling of four-component pixel data, consisting of red, green, blue and alpha (RGBA) components, often necessitates a system design incorporating four separate LUTs implemented as dedicated hardware. LUT operations are also very useful to implement non-linear operators, Galois multipliers for error correction, and many other digital signal processing applications where a processing-speed advantage is gained by pre-calculating a table (the LUT), so that run-time operation to accomplish the otherwise time-consuming calculation requires only indexing into a table of predetermined values.

Programmable processors of SIMD, superscalar or VLIW type increase performance by the techniques of parallelism and executing many operations during each processor-clock cycle. For example, the ICE chip from SGI can execute 8 operations, such as multiply-accumulate in one processor-clock cycle pipelined using SIMD architecture. This is also the case for AltiVec [4] SIMD processor from Motorola, and a VLIW processor from Equator. However, these processors do not have the capability to perform multiple LUT operations simultaneously. Such operations are performed as scalar operations, one LUT operation at a time, and therefore do not benefit from parallelism of processor architectures. This causes bottlenecks in processing because in a sequence of programmed operations, where finite impulse response (FIR) filtering and other computationally demanding operations may take advantage of parallelism in the architecture, each LUT operation is accomplished one operation at a time, that is, element by element without any parallelism.

One of the reasons that vector, that is, parallel LUT operations are not implemented in prior art is the additional memory required for these LUT memories. Accomplishing N parallel LUT operations would require N separate LUT memory modules in prior art.

### SUMMARY OF THE INVENTION

The present invention uses part of the data memory as Look-up Table (LUT) memory in order to accomplish multiple LUT operations during a single processor-clock cycle; this is a vector LUT operation. We can refer to each individual LUT operation as an “elemental” LUT operation, where a plurality of individual elemental LUT operations that occur simultaneously, that is, in parallel, form a vector LUT operation. The data memory is partitioned into N modules, where N is a positive integer. For single-input vector LUT operation, a specified number of least-significant bits from each of the elements of the input vector register are concatenated with high-order bits that specify a base address, in order to form the data memory address for each elemental LUT operation. The output data from each data memory module is stored into respective output vector register elements. An optional control vector register specifies the connections between the address input of each memory module, hence each “elemental” LUT, and any of the input vector register elements. Thus, one input vector element could produce N outputs using N different LUTs, or K input vector elements could produce N outputs, where K is an integer between one and N. The control vector register also provides a way to individually disable the elemental LUT operation for selected output elements. When disabled, the corresponding output vector register elements remain unchanged instead of being updated with the results of the LUT operation.

Another mode of operation is the dual-input vector LUT operation that takes two input vector registers as inputs to a LUT operation. A selected number of bits from each vector register's elements are concatenated, which is further concatenated with the high-order bits of base address.

Third mode of operation is loading a vector LUT entry from a specified source vector register. This loads all elements of a LUT, where the first input vector forms the addresses for each of the vector LUT elements, and the second vector register contains vector elements to write to these LUT entries. This finds application for quick update of certain LUT entries and histogram calculation.

### BRIEF DESCRIPTION OF THE DRAWINGS

The accompanying drawings, which are incorporated and form a part of this specification, illustrate embodiments of the invention, and together with the description, serve to explain the principles of the invention.

FIG. 1 illustrates a high-level block diagram of the invention.

FIG. 2 illustrates single-input vector LUT operation in block-diagram form. This figure shows using an embodiment of the present invention that has 32 elements per vector register. The data memory modules have consecutive addresses, i.e., data memory #0 through 31, which as an example make a 512-bit wide vector, using memory modules of 16-bit data width.

FIG. 3 illustrates effective-address generation for single-input vector LUT operations.

FIG. 4 illustrates mapping of input vector in vector LUT operations.

FIG. 5 illustrates the details of input element select logic that selects one of the N elements for each LUT input.

FIG. 6 illustrates dual-input vector LUT operation in block-diagram form. As in FIG. 1, this figure shows using an embodiment of the present invention that has 32 elements per vector register.

FIG. 7 shows effective-address generation for dual-input vector LUT operations. In this case, the input address is formed from the elements of the two source vector elements plus a base address to locate LUT as desired in the memory. For a LUT placed at memory location zero, the base address is not needed.

FIG. 8 shows details of vector LUT read and write instructions.

### DETAILED DESCRIPTION

In the following detailed description of the present invention, numerous specific details are set forth in order to provide a thorough understanding of the present invention. However, it will be obvious to one skilled on the art that the present invention may be practiced without these specific details. In other instances well-known methods, procedures, components, and circuits have not been described in detail so as not to unnecessarily obscure aspects of the present invention.

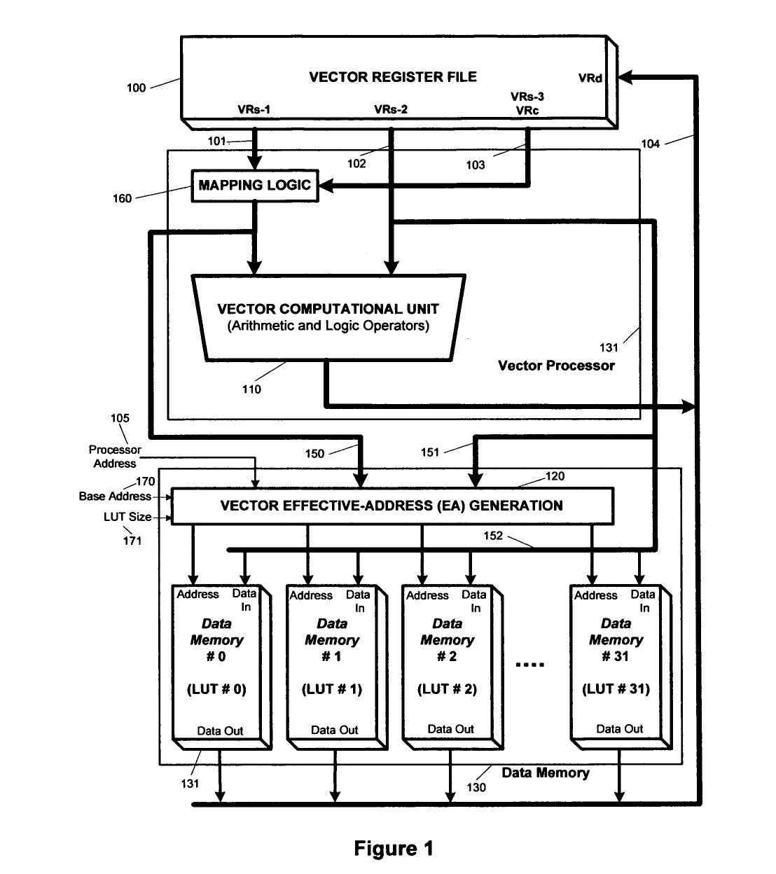

The present invention features a method for providing vector look-up table operations in single-instruction multiple-data (SIMD) operations in a computer system, as shown in FIG. 1. The preferred embodiment performs 32 LUT operations in a processor system having 512-bit wide data memory that is organized as 32 modules of on-chip memory, where each memory module is 16 data bits wide. The data memory 130 is used to store audio, video, graphics data or constants, and LUT contents. Although a data path of 512-bits and 32-vector elements is exemplified herein, the present invention is readily adaptable to other variations. The data memory 130 is accessed by load and store instructions for processing by vector computational unit 110, and by vector LUT (VLUT) instruction for parallel LUT operations.

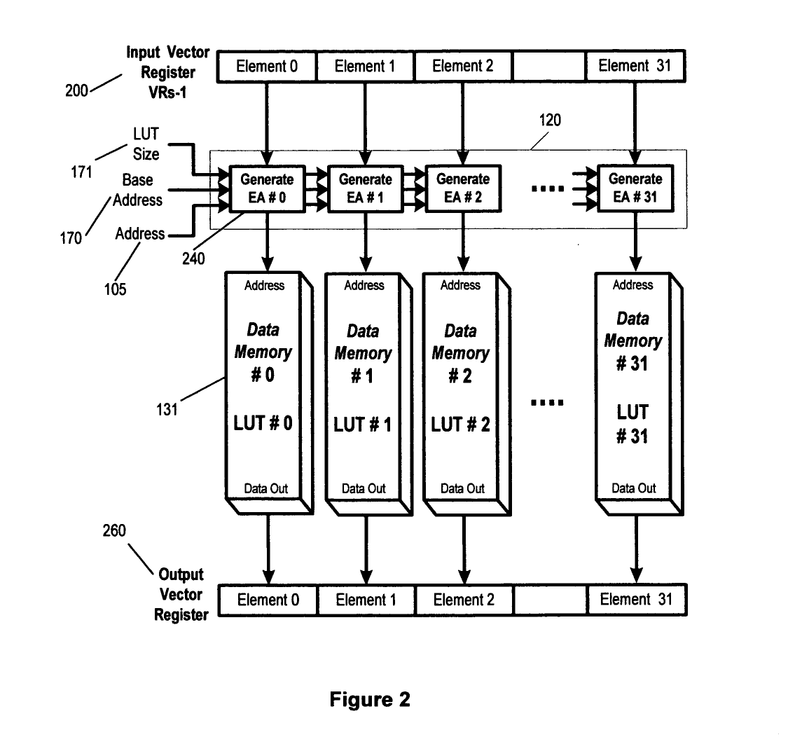

FIG. 2 illustrates a single vector-index vector LUT operation of present invention. The data memory is divided into at least N modules, where N is equal to the number of vector elements in SIMD. A source vector register 200 from vector register file is coupled to respective Generate EA #M module 240. The output of Generate EA modules is coupled to address inputs of respective partitioned data memory modules. The data output of each data memory module 131 is stored into an output vector register 260, which is also part of vector register file. For example, let us look at the example vector LUT instruction:

VLUT.8 VR1, VR0;

This vector LUT instruction performs 32 different LUT operations in parallel in one pipelined instruction clock cycle. The lower byte of VR0 source vector register elements act as index values for each respective LUT operation, and results of these 32 LUT operations are written into destination vector register VR1. Since each elemental LUT in this case has eight bits of index, shown as LUT size 171, signified by 8 in “VLUT.8” or as parameter “J”, we have 32 LUT tables where each table entry is 16-bits wide, the same width as the vector element.

The base address 170 of LUT in data memory is specified by a global control register. Alternatively, we could use another source vector register to specify base address for each vector element, but this additional flexibility seems to be of little additional value.

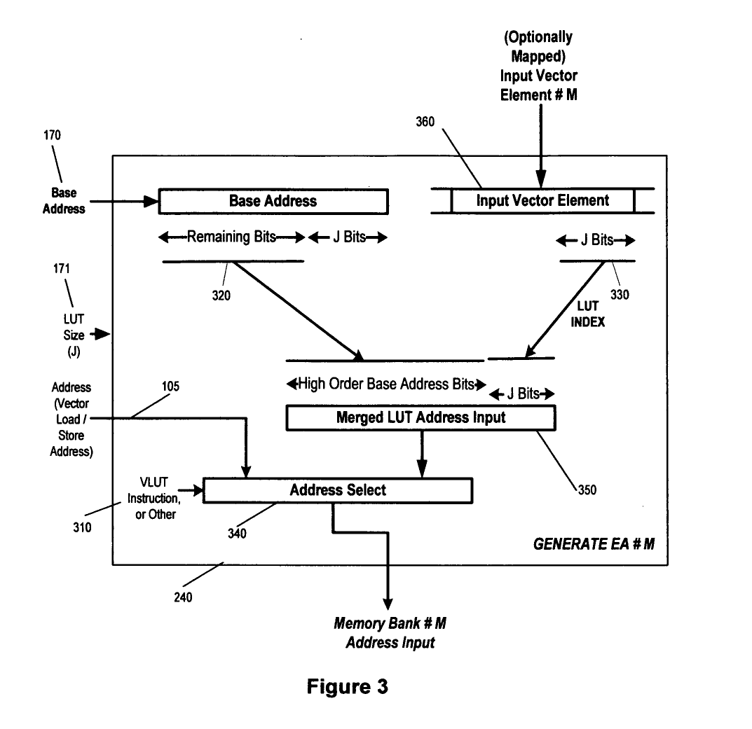

The details of Generate EA #M logic 240 shown in FIG. 3 provide means for generating addresses for the memory banks. The output address is selected from a vector load/store address 105 for prior art vector load and store operations. For VLUT operation, when VLUT instruction opcode is detected, the address selector control input 310 chooses the merged LUT address input of address select 340. This merged address field 350 is formed by J least significant bits 330 of each input vector element 360 which is merged with the remaining high-order address bits 320 of a base address 170. The remaining high-order bits of address 320 are bits J and higher address bits.

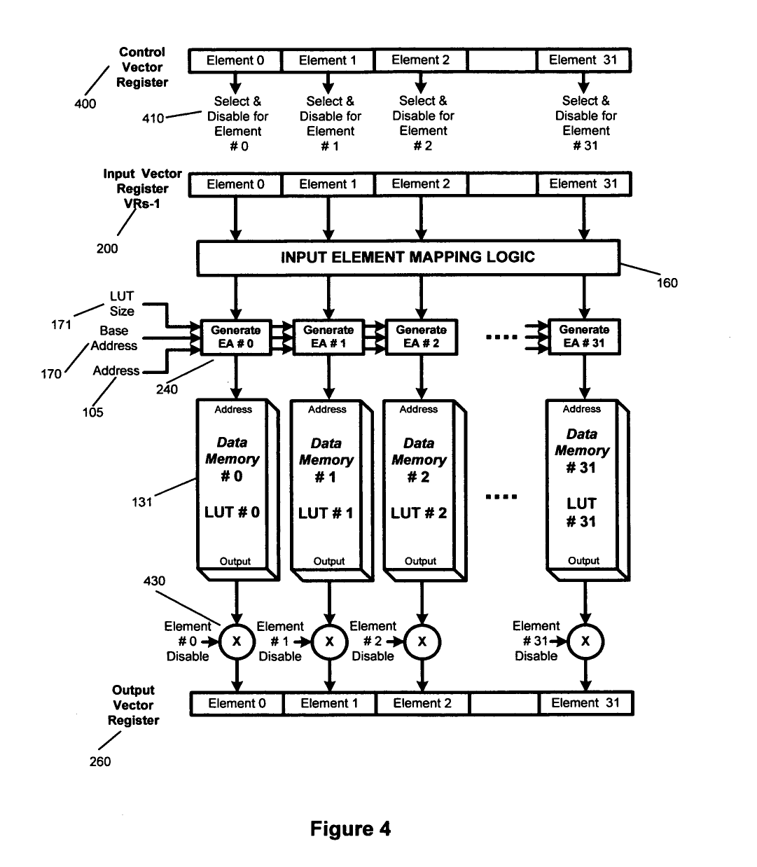

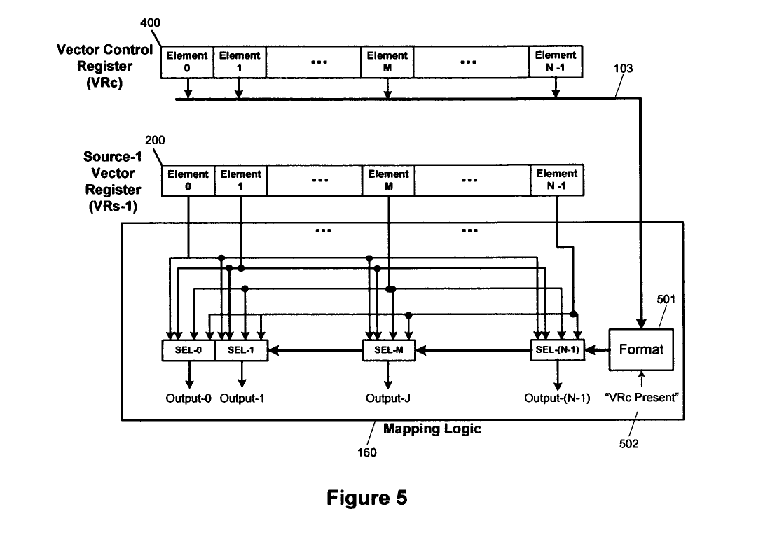

FIG. 4 illustrates a single-input vector LUT operation with input mapping logic. We refer to each individual LUT operation as an “elemental” LUT operation, where a plurality of individual elemental LUT operations that occur simultaneously, that is, in parallel, form a vector LUT operation. Input vector register 200 elements are fed to input element mapping logic 160, which selects one of the 32 elements for each element position. The mapping logic 160 is controlled by designated bit fields within each element of control vector register 400. Each element of this vector control register, 410 for element #0, specifies the input element number to select from source vector register 200 as the source of addressing for the corresponding elemental LUT operation position, and whether to disable the writing of the output of that LUT operation into the corresponding output vector register element. The details of the input element mapping logic 160 are shown in FIG. 5. If control vector VRc defining mapping is not specified as part of instruction, then no mapping is used and input 502 controls passing of input vector elements without mapping. For the preferred embodiment shown we use the following definitions of control bits for each element of the vector control register:

Bits 4 to 0: specifies input vector register element to use for LUT address input.

Bits 14 to 5: Not used.

Bit 15: active=1: Disable writing corresponding data memory (LUT) output element to output vector register.

This ability to selectively disable writing individual elements of output allows for efficient merging of results from multiple vector operations. The control blocks shown by circled “X” 430 in FIG. 4 control whether the output of each data memory is to be written to vector register 260.

The LUT size 171, as specified for all the LUTs by a vector LUT operation instruction, is the number of address bits for each LUT. For example, eight is used for a 256 entry LUT. The base address 170 is determined by a global control register (not shown), which specifies the base address of all LUTs in the data memory.

For each data memory module (each corresponding to a LUT), the effective address generation (EA) block 240 combines, bit-fields of base address and selected input element, to generate an effective address for each data memory module. The effective address is formed as concatenation of low-order J bits of the selected input element and the high-order address bits 320 specified as the base address 170, as shown in FIG. 3. In this case, the LUT size is 2^{J} entries.

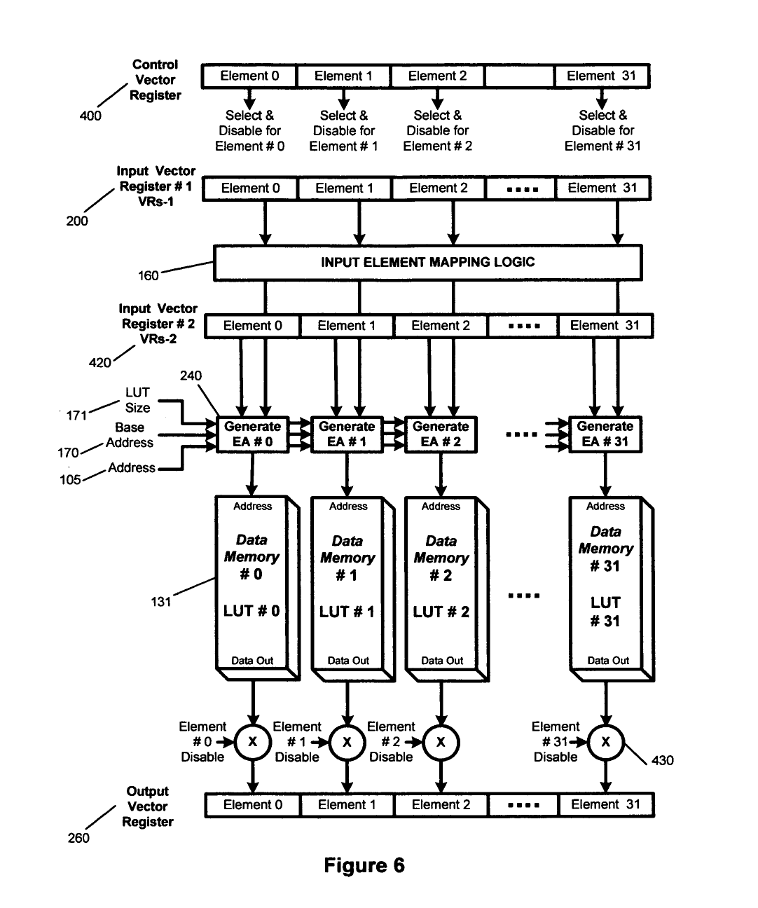

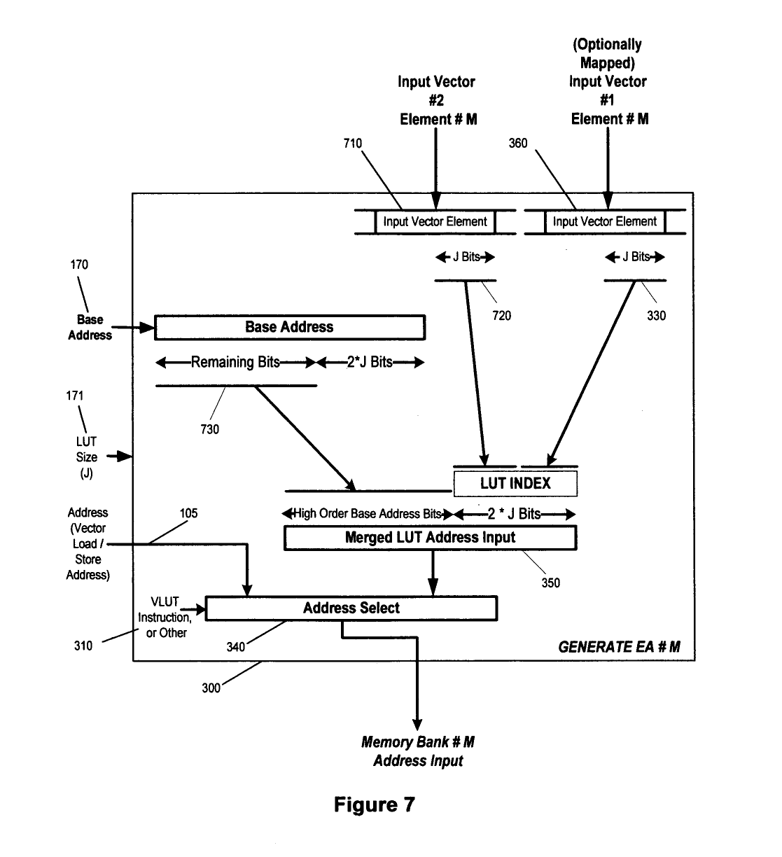

FIG. 6 shows the dual-input vector LUT operation. This diagram and operation are largely the same as for the single-input case. The effective address is formed differently than the single-input case, combining the least-significant J bits 330 and 720 of elements from both the first input vector 360, and now additionally second input vector register 420's elements 710, which are concatenated with remaining high-order address bits 730 of the base address 170, as shown in FIG. 7.

As in the single-input vector LUT operation case, the address bits selected from the first input vector register are selected from any of the first input vector register elements. In this case, the overall LUT size is 2^{2J} entries. For example, using the 4 least significant bits of two input vector register elements, each LUT contains all possible combinations for these two 4-bit entries in each LUT; hence each LUT has 256 entries, corresponding to 8 bits of address. Assuming 16-bit output for each LUT output and a 32 element-wide SIMD results in a total data memory requirement of 16,384 bytes (2 bytes wide by 256 entries per LUT by 32 elements). As semiconductor technology advances, larger on-chip memory bit capacity and therefore much larger LUT sizes will become practical. This will improve processor functionality without the addition of fixed-purpose dedicated logic. For example, Galois multipliers may be implemented using vectors LUT operations as described here. The Galois multiplier is frequently used in digital communications, in the implementation of error correction.

In general, each “elemental” LUT may contain contents identical to all the other individual LUTs, or each LUT may have different contents, depending upon the application. For many applications in a SIMD processing system, where the same processing operation is applied to multiple data-points, the LUT contents will be the same.

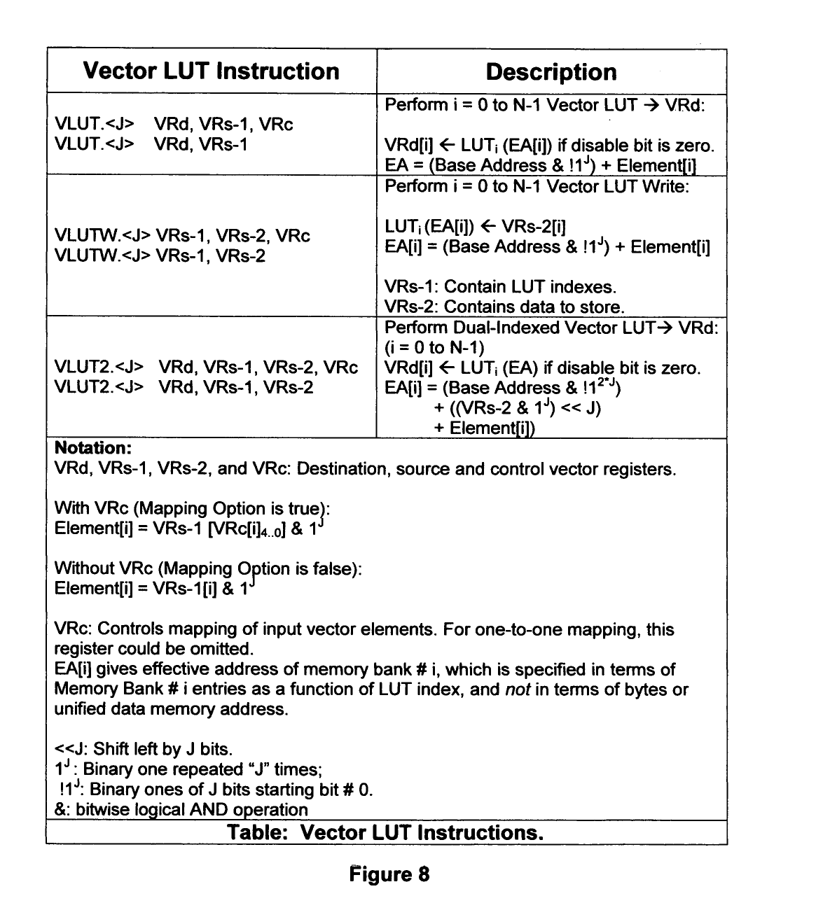

FIG. 8 shows vector LUT instructions for the preferred embodiment. The VLUT instruction invokes a single-input vector LUT operation. This instruction specifies an input source vector register, a control vector register, and an output vector register, which is the destination in which the results of the vector LUT operation are stored. The LUT size is specified by a constant J that denotes the number of LUT address bits, as part of the instruction. In this embodiment, a scalar base address register is dedicated to the function of specifying the base address for LUT operations. Since the base address register is dedicated to this purpose, there is no need for it to be explicitly identified in the call of the instruction.

In alternative embodiments, one may choose to use another source vector register to specify the base address for each vector element.

Using pseudo C programming language, we can describe the operation of VLUT as follows:

```
for (i = 0; i < N; i++)
  {
    if (“VRc Present” && VRc[i]₁₅ == 0)
        {
        VRd[i] ← MEMᵢ (Base_Address_{..J} + VRs
        [VRc[i]_{(log2(N)-1)..0}] _{(j-1)..0});
        }
    else if (“VRc Present” == False) VRd[i] ← MEMᵢ
    (Base_Address_{..J}+ VRs-1[i]_{(J-1)..0});
  }
```

Where N is the number of elements in SIMD processor and 2^{J} is the size of LUT per vector element. Base_Address_{( . . . J)} corresponds to remaining high-order bits 320 in FIG. 3. The subscripts such as “4 . . . 0” in “VRc[i]_{4 . . . 0}” specify bit-field ranges actually used. “ . . . J” signifies bit #J and higher-order bits. Each element of source vector one is mapped using index field from vector control register VRc. This is indicated by VRs [VRc[i]_{4 . . . 0}], in the case of preferred embodiment, which indicates that least significant five bits of a vector control register specifies the mapping for each source vector element. Instead of using J bits of a source vector element directly, these mapped source vector elements are used in accessing vector LUT entries.

The expression “VRs [VRc[i]_{(log 2(N)-1) . . . 0}]_{(j-1) . . . 0}” may be read as the number represented by quantity J relevant bits from the input source vector register element, that element being specified by the number represented in quantity log₂ N bits in the relevant control vector element.

VLUT instruction specifies the above operation, which is accomplished by means of the present invention, during one pipelined instruction cycle, which has the duration of one processor-clock cycle. It is assumed that the effective address (EA) is aligned to the boundary of vector LUT size, that is, that quantity (j+log₂ (N)+1) bits of the EA binary address are zeros. This is to avoid the need for an additional adder means per vector element in order to form the LUT address. With the alignment shown, the forming of address is simply a concatenation of address bits, without the need for an additional adder means.

In the embodiment shown, the source and destination vector registers are part of the same vector register file. In an alternative embodiment, an alternate vector register file may source the control vector register. The benefit of such an alternate vector register file is to provide constants and other source vectors to a vector operation without requiring additional ports means in the primary vector register file. The alternate vector register file is never used as a destination of a vector operation, and thus only requires one read and one write port. The alternate vector register file is written only by the scalar processing unit, assuming we have a scalar and vector unit working in parallel, that is, one scalar and one vector instruction are issued per processor-clock cycle.

A VLUTW instruction is used to write or update the contents of a vector LUT. The VLUTW instruction specifies both a source vector register that specifies the address 150 of the LUT entries to write, and another vector register containing the vector data to be written via bus 152.

The VLUT2 instruction invokes a dual-input vector LUT operation. This instruction specifies both a first and a second input vector register 420, a control vector register, and an output vector register which is the destination in which the results of the vector LUT operation are stored. The LUT size is specified by a constant J that denotes the number of LUT address bits used from each input vector register, as part of the instruction. The J least significant bits 330 of input vector #1 360 are concatenated with J-bit least significant bits 720 of input vector #2 element 710, and this is merged with high order address bits 730 of base address 170. For a dual-input vector LUT operation, the LUT address inputs are formed as shown in FIG. 7, and as earlier described, which differs from that for the single-input case. The control vector register specification is the same as for the VLUT (single-input vector LUT operation) case.

In different embodiments of the present invention, each vector element can be 8, 16, or 32-bits wide, and can be a fixed-point number or a floating point number. Different embodiments could also have different number of vector elements selected from the group consisting of 8, 16, 32, 64, 128, and 256.

### Examples of Vector LUT Operation

Hit-or-Miss morphological algorithms for binary images are often implemented by a pixel stacker followed by a LUT operation. The pixel stacker extracts the bits of a 3×3 pixel neighborhood kernel window and combines them into a single 8-bit value, excluding the center value. Then each pixel is passed through a LUT operation. Using SIMD vector LUT operations of the present invention we can perform N of these LUTs during a single processor-clock cycle, thus providing a processing speed advantage of a factor of N as compared to processing systems lacking such vector LUT operation capability.

Similarly, we may accomplish scaling of [Red, Green, Blue, Alpha], that is, RGBA pixel data, component values in video processing using vector LUT operations, where N/4 pixels may be processed in parallel.

### Dual-Issue Architecture

A preferred embodiment of the present invention uses at minimum a dual-issue processor, where during each clock cycle two instructions are issued: One scalar instruction and one vector instruction for SIMD operations. The scalar processor is a RISC type processor. The scalar processor primarily functions as a control processor and handles program flow as well as loading and storing of vector register file registers specified by special vector load and store instructions. The vector processor operates on the vector register file. Using dual-port data memory modules as the memory modules shown in FIGS. 1 and 4 provides the capability to accomplish vector LUT operations concurrently with the scalar processor's vector load and store operations.

1.-36. (canceled)

37. A method for performing a plurality of lookup table operations in parallel in one step in a processor, the method comprising:
providing a memory that is partitioned into a plurality of memory banks, each of said plurality of memory banks is independently addressable, the number of said plurality of memory banks is at least the same as a number of vector elements of at least one source vector, said memory is shared for use as a local data memory by said processor for access by load and store instructions and a plurality of lookup tables;
providing a vector register array with ability to store a plurality of vectors;
storing one of said plurality of lookup tables into each of said plurality of memory banks at a base address, said plurality of lookup tables each containing a plurality of entries;
storing said at least one source vector into said vector register array;
using index values to select entries of said plurality of lookup tables in accordance with respective elements of said at least one source vector, where j bits are used for said index values from elements of said at least one source vector;
calculating addresses for said plurality of memory banks in accordance with vector transfer operations and said plurality of lookup table operations, said addresses for said plurality of lookup table operations are calculated by one of adding respective said index values to said base address and concatenating respective said index values with high-order bits of said base address;
accessing said plurality of memory banks with respective said addresses for a read operation; and
storing data output of said read operation of each of said plurality of memory banks as a respective one of the vector elements of a destination vector, said destination vector being the same size as said at least one source vector.

38. The method of claim 37, further comprising:
storing a second source vector into said vector register array; and
performing a vector lookup table write operation, wherein respective elements of said second source vector is written into entries of said plurality of lookup tables, said entries selected in accordance with respective said index values of said at least one source vector.

39. The method of claim 37, further comprising:
storing a second source vector into said vector register array; and
forming said index values for dual-indexed lookup table operations by concatenating j least significant bits of said at least one source vector and j least significant bits of said second source vector.

40. The method of claim 37, further comprising:
storing a control vector into said vector register array;
mapping, in accordance with each vector element of said control vector, vector elements of said at least one source vector; and
using index values in accordance with mapped elements of said at least one source vector for calculations of said addresses of said plurality of lookup table operations.

41. The method of claim 37, further comprising:
storing a control vector into said vector register array; and
storing output of said plurality of lookup table operations to said destination vector of said vector register array is enabled in accordance with a mask bit of the respective vector element of said control vector on an element-by-element basis.

42. The method of claim 37, wherein said memory comprises two independent ports, a first port is used for performing said plurality of lookup table operations, and a second port is used for providing concurrent transfer of data.

43. The method of claim 37, wherein the value of said j is determined by a parameter of a vector look-up instruction.

44. An execution unit for performing n lookup table operations in parallel, the execution unit comprising:
a vector register file including a plurality of vector registers with a plurality of read data ports and at least one write data port, said vector register file is loaded with at least one source vector; each of said plurality of vector registers storing n vector elements, n being an integer no less than 2;
a data memory comprised of at least n memory banks, each of said at least n memory banks having independent addressing, said data memory is shared for storing input data, data processed by the execution unit, and a plurality of lookup tables, and said data memory coupled to said vector register file and an external data input-output device, wherein said data memory is directly accessed by load and store data transfer instructions of the execution unit;
selecting respective addresses for said at least n memory banks in accordance with said instructions of the execution unit, wherein said respective addresses are provided by one of data transfer instructions and a vector lookup table instruction, said respective addresses for said vector lookup table instruction are calculated by merging or concatenating index values and high-order bits of a base address of said n lookup tables, said index values are derived in accordance with a parameter j determining number of bits selected as said index values from respective elements of said at least one source vector; and
means for accessing said at least n memory banks with said respective addresses and storing data output of said at least n memory banks in respective elements of a destination vector register,
wherein n lookup table operations are performed in parallel with one clock cycle throughput.

45. The execution unit of claim 44, further including:
a second vector stored in said vector register file; and
means for storing elements of said second vector at said respective addresses of said at least n memory banks; and
whereby a vector lookup table update operation is performed using elements of said at least one source vector to form index values, and elements of said second vector is stored at entries of respective said plurality of lookup tables pointed by said index values.

46. The execution unit of claim 44, further including:
means for forming a dual-indexed lookup table index value for each respective vector element position in accordance with respective elements of two source vector registers and said parameter j; and
whereby a plurality of dual-indexed lookup table operations are performed and output of said plurality of dual-indexed lookup table operations are stored in respective elements of said destination vector register.

47. The execution unit of claim 44, further including:
at least one control vector stored in said vector register file;
means for mapping said at least one source vector in accordance with said at least one control vector; and
whereby said n lookup table operations are performed in accordance with mapped said at least one source vector as index values.

48. The execution unit of claim 44, further including:
at least one control vector stored in said vector register file; and
an enable logic coupled to said at least one write port of said vector register file for controlling storing elements of said destination vector register in said vector register file on an element-by-element basis in accordance with respective mask bits of said at least one control vector.

49. The execution unit of claim 44, wherein said n memory banks are dual ported, a first port of said n memory banks is used for said n lookup table operations, and a second port of said n memory banks is coupled to said external data input-output device, and transfer of data between said external data input-output device and said data memory and processing of data by the execution unit are performed concurrently.

50. The execution unit of claim 44, wherein each vector element of said plurality of vector registers is 8, 16, or 32 bits wide.

51. The execution unit of claim 44, wherein each vector element of said plurality of vector registers is a fixed-point number or a floating-point number.

52. (canceled)

53. The execution unit of claim 44, wherein said n is chosen from the group consisting of 8, 16, 32, 64, 128, and 256.
